(19) United States
(12) Patent Application Publication
(10) Pub. No.: US 2003/0072058 A1
(43) Pub. Date: Apr. 17, 2003

(54) Electronic appliance

(76) Inventor: Soren Kragh Jespersen, Sorup (DK)

Correspondence Address: Reza Green, Esq., Novo Nordisk, North America, Inc., 405 Lexington Avenue, Suite 6400, New York, NY, 10174-6401, US

(21) Appl. No.: 10/194,713

(22) Filed: Jul. 10, 2002

Related U.S. Application Data
(60) Provisional application No. 60/313,966, filed on Aug. 21, 2001.

(30) Foreign Application Priority Data
Aug. 9, 2001 (PA) 2001 01202

(51) Int. Cl. H04B 10/00

(52) U.S. Cl. 359/152; 359/172

(57) ABSTRACT

A portable electronic appliance such as a medication delivery device for administering a fluid medication to a mammal body, which electronic appliance comprises an optical communication unit for optical communication with another electronic device. The optical communication unit is provided inside the housing and transmits optical signals through an optical transparent window provided in an operating button which operating button operates a function which is normally not activated when the communication unit receives or transmits optical signals.

### THE TECHNICAL FIELD OF THE INVENTION

The invention relates to an electronic appliance having an optical communication port for wireless transfer of data to other electronic appliances.

1. Description of Related Art

U.S. Pat. No. 5,982,520 discloses a number of currently available electronic computing device which are able to transfer digital data wireless to other electronic devices through optical, infrared or radio link. The transceiver includes a wireless receiver and a wireless transmitter, which are used to transfer and receive the digital data. The transceiver is mounted on the casing of the electronic device.

An ambulatory recorder having wireless data transfer is disclosed in U.S. Pat. No. 6,200,264. The infrared transceiver is located inside the housing, and the housing is provided with an optical transparent part through which the infrared waves passes when data are being transferred.

U.S. Pat. No. 6,192,891 discloses a medication injection device having a data port through which data can be transferred to or from an external network.

2. Description of the Invention

In order to obtain a correct transfer of data it is important that the optical transparent part is not covered when the portable electronic appliance is commanded to communicate. When operating the known devices it is very easy either to hold or to operate the appliance in a way where the hand of the user or another part of the users body covers the optical transparent part preventing the optical signals in reaching the communication unit whereby the communication is obstructed.

Producers of portable electrical appliances such as mobile telephones, handheld computers, electronic notebooks, personal organizers or the like tend to minimize their appliances in order to enhance the portability. Due to this there is only a limited amount of space available on the housing to mount the optical transparent part on.

When locating the optical transparent part as specified in claim 1 it has surprisingly shown that the risk of covering the optical port during operation of the electronic appliance has decreased while on the other hand the optical transparent part do not occupy space on the surface of the housing, thereby leaving space available for other purposes.

Usually a user of a portable electronic appliance either operates the electronic appliance by operating the operating buttons, or the user transmits or receives data. Operation of the electronic appliance and transfer of data are very seldom done at the same time. Providing the optical transparent part in one of the operating buttons will therefore allow unobstructed passage of optical signals when the appliance is in a not active state i.e. when then the user do not touch the operating buttons.

At the same time a part of the surface of the housing are left free for other purposes. Since it is no longer necessary to occupy a part of the outside surface of the housing by an optical transparent part, this non-occupied surface space can be utilized to increase the size of the operating buttons making the appliance easier to operate.

The optical transparent part can either be an optical transparent window provided in the operating button whereby the button can be given any colour desired, or it can be the entire operating button made optical transparent.

In an embodiment of the invention, the optical transparent window or the operating button is made from a material, which allows passage of infrared waves. It can either be the colour of the material or the mechanical properties of the material, which allows the passage of infrared waves. Since electromagnetic waves in the infrared range are well known for transferring data between electronic appliances, the usage of infrared waves are preferred. The remaining part of the operating button could be made from a material, which excludes the passage of electromagnetic waves e.g. in the infrared range.

When, as disclosed in claim 5, the operating button provided with the optical transparent part, operates a function of the portable electronic appliance, which is normally not activated, when the communication unit receives and/or transmits signals, it is further ensured that the passage of the optical signals are not obstructed during transmission.

In a preferred embodiment the electrical appliance of the invention is an apparatus for measuring and/or monitoring blood glucose levels or a medication delivery device for administering medication to a human body, such as an injector, a jet injector, a syringe, a medication pump, an inhaler, a spray or the like. The electrical appliance could also be a combined injection device and blood glucose monitor. For controlling and regulating various diseases such as diabetes the transfer of data from the blood glucose monitor and/or the injection device to the medical doctor via a host computer is rapidly becoming more and more demanded in order to provide patients with a more precise regimen for the treatment of the disease.

It is also to be preferred that the operating button carrying the optical transparent part is the injection button since the injection button is usually the largest button on an injection device in order to facilitate both left handed and right handed users.

### BRIEF DESCRIPTION OF THE DRAWINGS

The invention will be explained more fully below in connection with a preferred embodiment and with reference to the drawings in which:

FIG. 1 Shows a sectional view of an electronic appliance according to the present invention.

FIG. 2 Shows a view of a medication delivery device according to an embodiment of the present invention

The figures are schematic and simplified for clarity, and they just show details, which are essential to the understanding of the invention, while other details are left out. Throughout, the same reference numerals are used for identical or corresponding parts.

### DETAILED DESCRIPTION OF EMBODIMENT

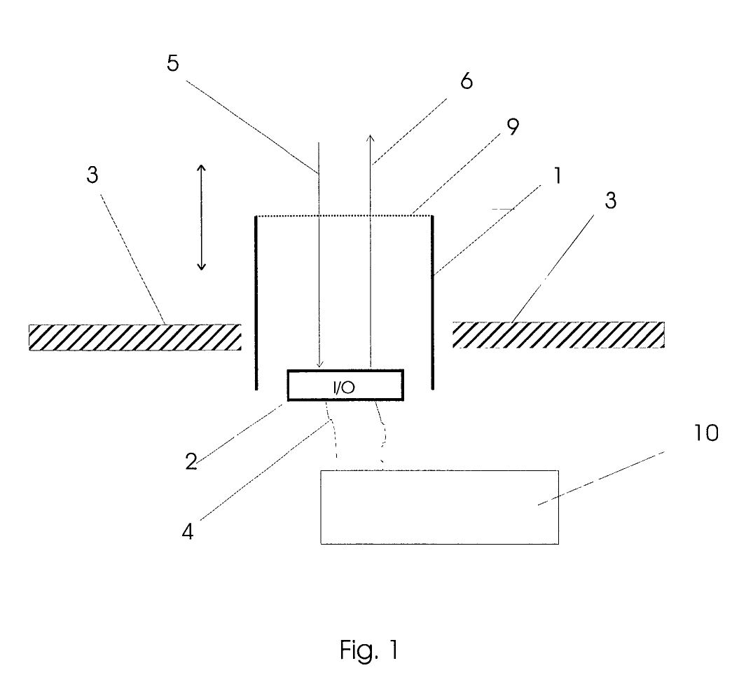

FIG. 1 shows a sectional view of a part of an electronic appliance 8. The electronic appliance 8 comprises a housing 3, which contains the various electronic circuits, the batteries and the medicament to be injected. At least one operating button 1 is mounted in the casing 3 such that the user of the electronic appliance 8 can activate a specific function by pressing the operating button 1.

Beneath the operating button 1 is located a optical communication unit 2 such as a transmitter, a receiver or a transceiver, which communication unit 2 includes a wireless receiver receiving an input signal 5 from another not shown electronic appliance and/or a wireless transmitter used to transfer an output signal 6 to the other electronic appliance. The communication unit 2 could be located either inside the operating button 1 or beneath the operating button 1 i.e. within the boundaries of the housing 3.

The communication unit 2 utilizes optical signals for the exchange of data. The wavelength of the optical signals used is in a preferred embodiment in the infrared range, such that the data communication follows the IRDA communication standard.

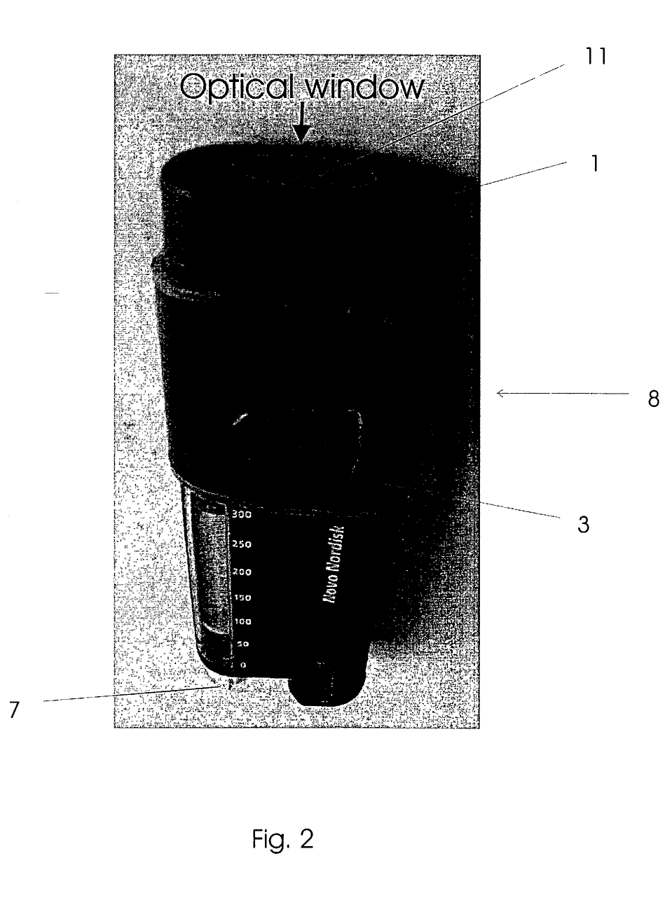

As shown in FIG. 1 the operating button 1 has a part 9 which is optical transparent, meaning that the part 9 is made from a material, which is optically transparent such that the optical signals 5, 6 can pass unobstructed through the optical transparent part 9. The optical transparent part 9 can be the top of the operating button as shown in FIG. 1 or it can be any part of the operating button 1. In one embodiment the entire button 1 is the optical transparent part 9. As can be seen in FIG. 2 the optical transparent part 9 is an optical window 11 located in the top surface of the operating button 1. It could however be located in another surface of the operating button 1, or even in a number of surfaces.

The operating button 1 with the optical transparent part 9 could be moulded in one piece from one or more different polymeric materials or at least from different colored polymeric materials. The coloration of the operating button 1 could however also be done after the moulding. The optical transparent part 9 could also be a separate part, which is connected to the operating button 1.

The transparent part 9 can be made from a material or a color, which only allows passage of infrared waves while excluding passage of electromagnetic waves outside the infrared range, such that the transfer of data can be obtained without any disturbance.

The electronic appliance could e.g. be a medication delivery device of the type known as the Innovo® from the company Novo Nordisk. This medication delivery device shown in FIG. 2 has a housing 3 containing the various electronic circuits, the batteries, a cartridge holding the medication and a number of mechanical parts transferring the movement of the injection button 1 to a movement of a piston located in the cartridge, which movement presses medication out through the injection needle 7. The medication delivery device could also be made with a number of electromechanical parts such as an electrical motor, which electrical motor is then used to expel the medication through the injection needle 7.

The injection of the medication is executed by pressing the injection button 1. Prior to an injection various data concerning the injection device 8 can be transmitted from the injection device 8 to a host computer using infrared transmission through the optical transparent window 11. Patient related data could in the same way be transmitted from the host computer to the injection device 8 through the optical transparent window 11.

The injection button 1 on an injection-device 8 is normally made quite large, such that the same injection device can be used both by left handed and by right handed people, leaving sufficient space for the optical transparent window 11 in the injection button 1.

Some preferred embodiments have been shown in the foregoing, but it should be stressed that the invention is not limited to these, but may be embodied in other ways within the subject matter defined in the following claims.

1. A portable electronic appliance (8) comprising a housing (3), an optical transparent part (9) and an optical communication unit (2) such as a transmitter, a receiver or a transceiver (2) for receiving and/or transmitting optical signals (5, 6) through the optical transparent part (9), characterized in that, said housing (3) further comprises an operating button (1), which operating button (1) is provided with the optical transparent part (9).

2. A portable electronic appliance according to claim 1, characterized in that the optical transparent part (9) is an optical transparent window (11).

3. A portable electronic appliance according to claim 1, characterized in that the entire operating button (1) is the optically transparent part (9).

4. A portable electronic appliance according to claim 2 or 3, characterized in that the optical transparent window (11) or the operating button (1) is made from a material which allows passage of infrared waves.

5. A portable electronic appliance according to claim anyone of the preceding claims, characterized in that the operating button (1) operates a function of the portable electronic appliance (8), which is normally not activated, when the communication unit (2) receives and/or transmits signals (5, 6).

6. A portable electronic appliance according to anyone of the preceding claims, characterized in that, the electrical appliance 8 is an apparatus for measuring and/or monitoring blood glucose levels.

7. A portable electronic appliance according to anyone of the preceding claims, characterized in that, the electrical appliance (8) is a medication delivery device for administering medication to a mammal body, such as an injector, a jet injector, a syringe, a medication pump an inhaler, a spray or the like.

8. A portable electronic appliance according to anyone of the preceding claims, characterized in that, the electrical appliance (8) is a combined injection device and blood glucose monitor

9. A portable electronic appliance according to claim 7 or 8, characterized in that, the operating button (1) carrying the optical transparent part is the injection button.
